(19) United States
(12) Patent Application Publication
(10) Pub. No.: US 2013/0239673 A1
(43) Pub. Date: Sep. 19, 2013

(54) Systems and Methods for Collecting One or More Measurements in a Borehole

(71) Applicants: Fernando Garcia-Osuna, Sugar Land, TX (US); Jan Morley, Houston, TX (US); Luis E. Depavia, Sugar Land, TX (US); Brian E. Boling, Sugar Land, TX (US); Reza Taherian, Sugar Land, TX (US); David Oliver, Sugar Land, TX (US); Christopher S. Del Campo, Houston, TX (US)

(72) Inventors: Fernando Garcia-Osuna, Sugar Land, TX (US); Jan Morley, Houston, TX (US); Luis E. Depavia, Sugar Land, TX (US); Brian E. Boling, Sugar Land, TX (US); Reza Taherian, Sugar Land, TX (US); David Oliver, Sugar Land, TX (US); Christopher S. Del Campo, Houston, TX (US)

(73) Assignee: SCHLUMBERGER TECHNOLOGY CORPORATION

(21) Appl. No.: 13/805,670

(22) PCT Filed: Jun. 24, 2011
(86) PCT No.: PCT/US11/41845

§ 371 Date: Jun. 3, 2013

Related U.S. Application Data
(60) Provisional application No. 61/358,337, filed on Jun. 24, 2010.

(51) Int. Cl. G01V 9/00; G01V 5/04; G01V 3/18

(52) U.S. Cl. CPC G01V 9/00; G01V 3/18; G01V 5/045
USPC 73/152.46; 324/347; 324/333; 250/254

(57) ABSTRACT

A system and method collects at least one measurement within a borehole formed in a formation. The system and method provides a drill collar made of a non-conductive or substantially non-conductive composite material positioned within the borehole. A downhole component is capable of collecting at least one measurement and is embedded within the composite material of the drill collar. The at least one measurement collectable by the downhole component is related to the borehole or the formation about the borehole.

### BACKGROUND OF THE DISCLOSURE

A wellbore or borehole (hereinafter “borehole”) is generally drilled into the ground to recover natural deposits of hydrocarbons and/or other desirable materials trapped in a subsurface geological formation (hereinafter “formation”) in the Earth's crust. The borehole is drilled to penetrate the formation in the Earth's crust that contains the trapped hydrocarbons and/or other materials. As a result, the trapped hydrocarbons and/or materials are released from the formation and/or recovered via the borehole.

Traditionally, downhole components, such as tools, electronics, sensors and/or devices are positioned within the borehole to collect one or more measurements associated with the borehole, the formation and/or the like. One or more of the downhole components are typically housed in one or more drill collars and/or tools which may be located within a drill string or in a bottom hole assembly (hereinafter “the BHA”) of the drill string. For example, the downhole components housed in drill collars located within the borehole may collect one or more measurements associated with one or more characteristics and/or properties, for example, relating to a drill bit mounted to the BHA, the drill string, the BHA, the borehole, the formation surrounding the borehole and/or the like.

However, traditional drill collars are made of one or more conductive or metallic materials that interfere or degrade with the measurements being collected by downhole components housed within the drill collars. Often, the drill collars are slotted metallic collars which negatively affect or degrade measurements collected by the downhole components housed within the drill collars. Sometimes, the downhole components have sensors that must be protected with a shield which typically is made of metallic material and negatively affects measurements being collected by the sensors. For example, a downhole tool may be housed within a drill collar made of steel which may interfere with and/or prevent the downhole tool from collecting necessary measurements, such as, for example, electromagnetic wave measurements, gamma ray radiation measurements and/or the like. As a result, the downhole tool, housed in the conductive steel drill collar, may not be able to accurately and/or efficiently collect the necessary measurements associated with the characteristics and/or properties of the drill bit, the drill string, the BHA, the borehole and/or the formation.

### BRIEF DESCRIPTION OF THE DRAWINGS

FIG. 1 illustrates a diagram of a wellsite system in accordance with embodiments of the present invention and which can be used in practicing embodiments of the method of the present invention.

FIG. 2 illustrates a diagram of a drill string system in accordance with embodiments of the present invention and which can be used in practicing embodiments of the method of the present invention.

FIG. 3 illustrates a side view of a composite shield protecting a downhole component in accordance with embodiments of the present invention and which can be used in practicing embodiments of the method of the present invention.

FIG. 4 illustrates a side view of a half-shell composite shield protecting a downhole component in accordance with embodiments of the present invention and which can be used in practicing embodiments of the method of the present invention.

FIG. 5 illustrates a perspective view of a composite shield in accordance with embodiments of the present invention and which can be used in practicing embodiments of the method of the present invention.

FIG. 6 illustrates a perspective view of a half-shell composite shield in accordance with embodiments of the present invention and which can be used in practicing embodiments of the method of the present invention.

FIG. 7 illustrates a perspective view of a composite shield in accordance with embodiments of the present invention and which can be used in practicing embodiments of the method of the present invention.

FIG. 8 illustrates a perspective view of a half-shell composite shield in accordance with embodiments of the present invention and which can be used in practicing embodiments of the method of the present invention.

FIG. 9 illustrates a diagram of a composite drill collar incorporated into a bottom hole assembly in accordance with embodiments of the present invention and which can be used in practicing embodiments of the method of the present invention.

FIG. 10 illustrates a diagram of a system having inner coils of a mandrel located inside outer coils of a composite drill collar in accordance with embodiments of the present invention and which can be used in practicing embodiments of the method of the present invention.

FIG. 11 illustrates a diagram of a system having inner coils of a mandrel located inside outer coils of a composite drill collar in accordance with embodiments of the present invention and which can be used in practicing embodiments of the method of the present invention.

FIG. 12 illustrates a diagram of a system having inner coils of a mandrel located between two sets of outer coils of a composite drill collar in accordance with embodiments of the present invention and which can be used in practicing embodiments of the method of the present invention.

FIG. 13 illustrates a diagram of a system having inner coils of a mandrel inside outer coils of a composite drill collar with a sensor in accordance with embodiments of the present invention and which can be used in practicing embodiments of the method of the present invention.

FIG. 14 illustrates a diagram of a drill string having composite short pipes in accordance with embodiments of the present invention and which can be used in practicing embodiments of the method of the present invention.

FIG. 15 illustrates a diagram of piezoelectric strips for composite short pipes in accordance with embodiments of the present invention and which can be used in practicing embodiments of the method of the present invention.

FIG. 16 illustrates a diagram of a composite housing for downhole components in accordance with embodiments of the present invention and which can be used in practicing embodiments of the method of the present invention.

FIG. 17 illustrates a diagram of a flow line connection formed by composite housings in accordance with embodiments of the present invention and which can be used in practicing embodiments of the method of the present invention.

FIG. 18 illustrates a diagram of a flow line connection formed by composite housings in accordance with embodiments of the present invention and which can be used in practicing embodiments of the method of the present invention.

FIG. 19 illustrates a diagram of a composite acoustic attenuator in accordance with embodiments of the present invention and which can be used in practicing embodiments of the method of the present invention.

FIG. 20 illustrates a diagram of a composite acoustic attenuator in accordance with embodiments of the present invention and which can be used in practicing embodiments of the method of the present invention.

FIG. 21 illustrates a diagram of a composite acoustic attenuator in accordance with embodiments of the present invention and which can be used in practicing embodiments of the method of the present invention.

FIG. 22 illustrates a diagram of a composite drill collar having isolated electrodes in accordance with embodiments of the present invention and which can be used in practicing embodiments of the method of the present invention.

FIG. 23 illustrates a diagram of a wellsite system and target well in accordance with embodiments of the present invention and which can be used in practicing embodiments of the method of the present invention.

### EMBODIMENTS

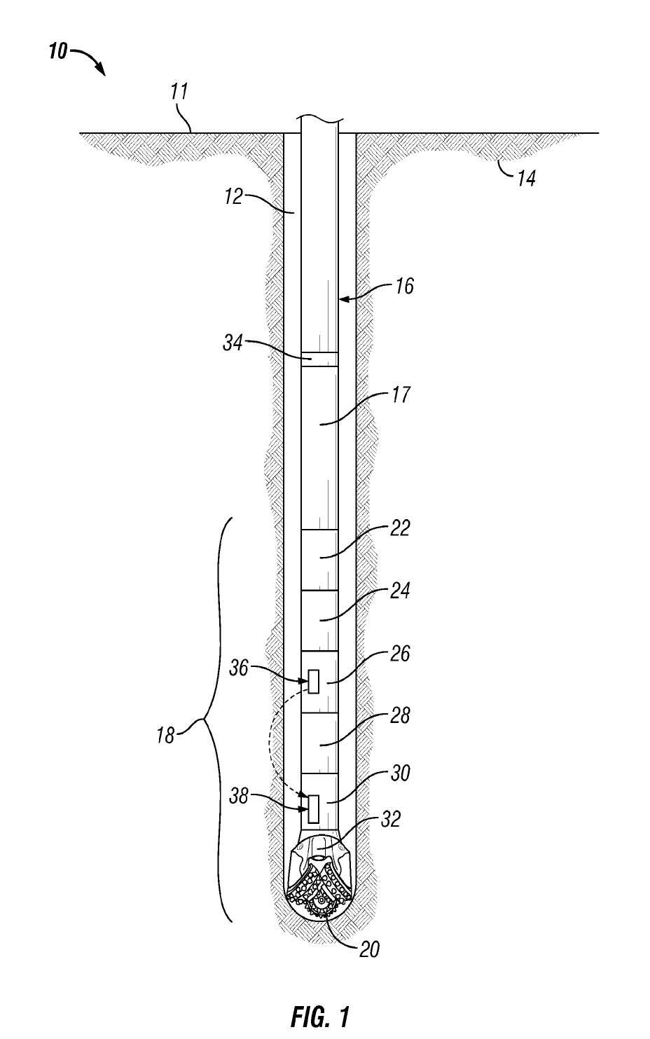

Referring now to the drawings wherein like numerals refer to like parts, FIG. 1 illustrates a wellsite system 10, which may be onshore or offshore, in which the present systems and methods for collecting one or more measurements in a borehole 12 may be employed. The borehole 12 is formed in subsurface formations 14 by rotary drilling in a manner that is well known. Embodiments of the invention may be used with vertical, horizontal and/or directional drilling.

The wellsite system 10 may include a drill string 16 suspended within the borehole 12. For example, the drill string 16 may be a wireline logging tool string and/or may include one or more drill pipes 17. The wellsite system 10 is used as an example system in which the invention may be incorporated, but a person having ordinary skill in the art will understand that the invention may be used in any downhole application, such as logging, formation evaluation, drilling, sampling, reservoir testing, completions, or abandonment of the borehole 12. A bottom hole assembly 18 (hereinafter “BHA 18”) and a drill bit 20 may be coupled to and/or connected to a lower end of the drill string 16 below drill pipes 17. Rotation of the drill bit 20 and/or the drill string 16 may move the drill string 16 and BHA 18 through the borehole 12. It should be understood that drill string 16 may include any number of drill pipes 17 as known to one of ordinary skill in the art.

The BHA 18 of the drill string 16 may include one or more downhole components 22, 24, 26, 28, 30, 32 (hereinafter “the downhole components 22, 32” for simplicity) for collecting one or more measurements relating to one or more characteristics and/or properties associated with the borehole 12, the formation 14, the drill string 16, the BHA 18 and/or the drill bit 20. It should be understood that the BHA 18 may include any number of downhole components as known to one of ordinary skill in the art.

The downhole components 22, 32 may be a tool, a power source, a coil, an antenna, an electrode, a sensor, or another downhole component of the drill string 16 as known to one of ordinary skill in the art. For example, the downhole components 22, 32 may be tools, sensors, or other devices for collecting one or more measurements relating to one or more characteristics and/or properties associated with the formation 14, the drill string 16, the BHA 18, the drill bit 20 and/or the borehole 12. The downhole components 22, 32 may each be housed in a drill collar, as is known in the art, and/or may contain one or a plurality of known types of telemetry, survey or measurement tools, such as, logging-while-drilling tools (hereinafter “LWD tools”), measuring-while-drilling tools (hereinafter “MWD tools”), near-bit tools, on-bit tools, and/or wireline configurable tools (hereinafter “wireline tools”). In embodiments, the one or more drill collars may be an individual component of the BHA 18 and/or may be incorporated into one or more LWD tools and/or MWD tools which may be included in the BHA 18.

The LWD tools may include capabilities for measuring, processing, and storing information, as well as for communicating with surface equipment. Additionally, the LWD tools may include one or more of the following types of logging devices that measure formation characteristics and/or properties: a resistivity measuring device; a directional resistivity measuring device; a sonic measuring device; a nuclear measuring device; a nuclear magnetic resonance measuring device; a pressure measuring device; a seismic measuring device; an imaging device; a formation sampling device; a natural gamma ray device; a density and photoelectric index device; a neutron porosity device; and a borehole caliper device. It should be understood that the downhole components 22, 32 may be any LWD tool as known to one or ordinary skill in the skill.

The MWD tools may include one or more devices and/or sensors for measuring characteristics and/or properties of the borehole 12, the formation 14, the drill string 16, the BHA 18 and/or the drill bit 20. The MWD tools may include one or more of the following types of measuring devices: a weight-on-bit measuring device; a torque measuring device; a vibration measuring device; a shock measuring device; a stick slip measuring device; a direction measuring device; an inclination measuring device; a natural gamma ray device; a directional survey device; a tool face device; a borehole pressure device; and a temperature device. The MWD tools may detect, collect and/or log data and/or information about the conditions at the drill bit 20, around the formation 14, at a front of the drill string 16 and/or at a distance around the drill string 16. It should be understood that the downhole components 22, 32 may be any MWD tool as known to one of ordinary skill in the art.

The wireline tools may be a tool commonly conveyed by wireline cable as known to one having ordinary skill in the art. For example, the wireline tools may be logging tools for sampling or measuring characteristics and/or properties of the formation 14, such as gamma radiation measurements, nuclear measurements, density measurements, resistivity measurements and/or porosity measurements. In embodiments, the one or more downhole components 22, 32 may be a well completion tool for extracting reservoir fluids after completion of drilling. It should be understood that the downhole components 22, 32 may be any wireline tool as known to one of ordinary skill in the art.

In an embodiment, the downhole components 22, 32 may be or may include one or more transmitters, receivers and/or sensors (hereinafter “sensors”) that may be housed within one or more drill collars and/or one or more walls of the one or more drill collars. The sensors may be in communication with the BHA 18, the downhole components 22, 32, other downhole components and/or one or more additional sensors associated with the downhole components 22, 32. It should be understood that the drill string 16, the BHA 18 and/or the downhole components 22, 32 may include any number of sensors and the sensors may be any sensor as known to one of ordinary skill in the art.

In embodiments, the downhole components 22, 32 may include sensors that may detect, collect, log and/or store data concerning the operation of the wellsite 10, the borehole 12, the formation 14, the drill string 16 and/or the drill bit 20. For example, the sensors of the downhole components 22, 32 may be provided to measure parameters such as standpipe pressure, hookload, depth, surface torque, rotary rpm and the like. The sensors of the downhole components 22, 32 may detect, collect, log and/or store any data that may be detected, collected, logged and/or stored as known to one of ordinary skill in the art.

In embodiments, the sensors of the downhole components 22, 32 may be provided in an interface to measure various wellbore parameters, such as temperature, pressure (standpipe and/or mud), mud flow, noise, vibration and/or drilling mechanics (i.e. torque, weight, acceleration and/or pipe rotation). The sensors of the downhole components 22, 32 may also be linked to an analog front end for signal conditioning and/or to a processor for processing and/or analyzing data. The sensors of the downhole components 22, 32 may also be used to perform diagnostics. The diagnostics can be used to locate faults in the drill string 16, measure noise and/or characteristics associated with the drill string 16, the BHA 18 and/or the drill bit 20 and perform other diagnostics of the wellsite 10.

The sensors of the downhole components 22, 32 may detect, collect and/or log data associated with resistivity of the formation, such as, for example, attenuation and phase shift resistivity at different transmitter spacing and frequencies, resistivity at the drill bit 20 and/or deep directional resistivity. The sensors of the downhole components 22, 32 may detect, collect and/or log data associated with formation slowness, such as, for examples, compressional slowness and shear slowness. In addition, the sensors of the downhole components 22, 32 may detect, collect and/or log formation images, such as, for example, density borehole images and/or resistivity borehole images. Furthermore, the sensors of the downhole components 22, 32 may detect, collect and/or log data associated with formation pressure and/or formation fluid samples. Still further, the sensors of the downhole components 22, 32 may detect, collect and log data associated with total gamma rays, spectral gamma rays and/or azimuthal gamma rays. The sensors of the downhole components 22, 32 may also detect, collect and/or log data associated with formation caliper, such as, for example, ultra sonic azimuthal caliper and/or density caliper. It should be understood that the data and/or information detected, collected, logged and/or stored by the sensors of the downhole components 22, 32 may be any data and/or information as known to one of ordinary skill in the art.

The downhole components 22, 32 may comprise, may include or may incorporate one or more power sources (not shown in the drawings). The power source may be, for example, a power turbine and/or motor, a generator, a capacitor, a battery, a rechargeable battery, land-line extending from the Earth's surface 11 (hereinafter “surface 11”) into the borehole 12. In embodiments, the drill pipes 17 of the drill string 16 may be wired drilling pipe which may provide electrical power or electrical energy downhole to the BHA 18 and/or the downhole components 22, 32. In embodiments, the downhole components 22, 32 may be a power source itself or the power source may be located and/or connected to the drill string 16. The power source may produce and may generate electrical power or electrical energy to be distributed throughout the drill string 16 and/or the BHA 18 and/or may power the downhole components 22, 32. It should be understood the power source may be any other electrical power generating source as known to one of ordinary skill in the art

The present disclosure should not be deemed as limited to a specific embodiment of the tools for the downhole components 22, 32. While the above description sets forth a description of the downhole components 22, 32 with respect to the drill string 16, it should be appreciated by those having ordinary skill in the art that the invention should not be deemed as limited to only drilling applications. It should be understood that the drill string 16 may include any number and any type of downhole components as known to one of ordinary skill in the art.

The drill string 16, the BHA and/or the downhole components 22, 32 may include one or more uphole components 34 (hereinafter “uphole components 34”), such as, for example, an uphole interface to provide an interface between communications circuitry of a telemetry system and the BHA 18 and/or the downhole components 22, 32. The uphole interface of the uphole components 34 may transmit and/or radiate telemetry communications received by the telemetry system of the uphole interface from the BHA 18 and/or the downhole components 22, 32 to the surface 11 as known to one of ordinary skill in the art. The telemetry system may comprise one or more of the following telemetry systems: mud pulse telemetry, acoustic telemetry, electromagnetic telemetry, wired drill pipe telemetry, wireline telemetry or any other data transmission methods as known to one of ordinary skill in the art. The present disclosure should not be deemed limited to a specific embodiment of the telemetry utilized by the telemetry system of the uphole interface 34.

In embodiments, the uphole components 34 may be, for example, low-power telemetry repeaters, pressure sensors, temperature sensors, acoustic sensors, mud sensors and/or other low-power sensors, which may be located between two separate adjacent drill pipes 17 within the drill string 16. The repeater and/or the temperature sensor of the uphole components 34 may increase and/or intensify telemetry communications transmitted to the surface 11 from the BHA 18 and/or the downhole components 22, 32. The uphole components 34 may be any component located within and/or positioned in the drill string 16 as known to one of ordinary skill in the art.

The downhole components 22, 32 may be one or more drill collars or may have one or more drill collars incorporate therein to form, for example, a wireline logging tool string 100 as shown in FIG. 2. For example, the downhole components 22 and 24 may have drill collars which may be connected to the drill string 16 to form the BHA 101 or a portion of the bottom hole assembly 101 (hereinafter “BHA 101”) of the wireline logging tool string 100.

The drill collars or one or more portions of the drill collars may be made of a composite material. In embodiments, the one or more portions of the drill collars may include a wall 102 of the drill collars, one or more connectors 104 of the drill collars and/or other components of the drill collars. The present specification should not be deemed as limit to a specific embodiment of the portion(s) of the one or more drill collars that may be made of the composite material.

The composite material may be a lower density non-conductive, non-magnetic, and substantially non-conductive or a substantially non-magnetic composite material. As a result, the drill collars and/or the portions of the one or more drill collars may be conductively and/or magnetically transparent or substantially transparent to one or more downhole components 106 (hereinafter “downhole components 106”) and/or one or more sensors 108 (hereinafter “sensors 108”) which may be housed within, embedded within and/or located within the drill collars and/or the wall 102 of the drill collars.

In embodiments, the composite material may be a high-temperature, high strength, chemical resistant and/or wear resistant composite material. The composite material may be, for example, a fiber reinforced polymer composite material. In embodiments, the composite material may be made from a combination of one or more fiber materials and one or more resin matrixes. For example, the composite material may be made of an epoxy matrix reinforced with carbon fibers. It should be understood that the present specification should not be deemed as limited to a specific embodiment of the composite material which may be any composite material that is non-conductive or substantially non-conductive and suitable for use in the borehole 12.

In embodiments, the downhole components 22 and 24 may be drill collars sized and/or adapted to receive and/or secure, for example, the wireline logging tool string 100. The downhole components 106 may be, for example, wireline tools which may include the sensors 108 and/or be housed in or located within the one or more drills collars and/or within the wall 106 of the drill collars. The wireline tools 106 and/or the sensors 108 may be connected to wireline 110 as known to one of ordinary skill in the art and/or positioned within the drill collars via the wireline 108. The drill collars and/or portions of the drill collars made of composite material (hereinafter “composite drill collars”) and the wireline logging tool string may form the BHA 101 which may be conveyed in the borehole 12 via the drill string 16 and/or may be used for formation evaluation and/or logging operations. Optionally, the drill string 16 and the BHA 101 may be configured and/or adapted to be used for drilling the borehole 12. Moreover, the wireline tools 106 and/or the sensors 108 may be any wireline tools and/or any sensors, respectively, as known to one of ordinary skill in the art.

The wireline tools 106 and/or the sensors 108 housed within the composite drill collars may collect one or measurements relating to one more characteristics and/or properties of, for example, formation 14 surrounding the borehole 12. The drill collars made of non-conductive or substantially non-conductive composite material do not interfere with or prevent the wireline tools 106 and/or the sensors from collecting one or more measurements associated with properties of the formation 14 surrounding the borehole 12, such as, for example, electromagnetic (hereinafter “EM”) waves measurements, gamma ray radiation measurements, nuclear measurements, acoustic measurements, surveying measurements and/or the like. The composite drill collars may be transparent or substantially transparent to the EM waves, gamma ray radiation, nuclear, acoustic and surveying measurements and/or other measurements associated with the formation 14.

The one or more wireline tools 106 and/or the one or more sensors 108 may collect the measurements associated with the formation 14 through the drill collar without or substantially without any interference from the composite material of the drill collars. As a result, the composite drill collars will not require one or more slots within the wall 102 and/or ceramic sleeves to allow the measurements to be collected by the wireline tools 106 and/or the sensors 108 housed within the composite drill collars. The measurements collected by the one or more wireline tools 106 and/or the one or more sensors 108 may be enhanced by the transparency or substantial transparency of the composite drill collar to measurements, such as, for example, electromagnetic, nuclear, resistivity, acoustic and/or surveying measurements. As a result, the composite drill collars may allow the wireline tools 106 and/or the sensors 108 to collect improved measurements in what is known as tough logging conditions.

The connectors 104 of the composite drill collars may be male or female plugs configured to connect to ends of the wireline tools 106. A pair of connectors 104 having both male plug and a female plug may form a threaded connection 112 to secure the composite drill collars together. Securing and connecting devices 114 (hereinafter “devices 114”) may connect the wireline tools 106 to the connectors 104 of the composite drill collars and/or to the composite drill collars themselves. As a result, the wireline tools 106 may be connected, attached and/or secured to the connectors 104 and/or the composite drill collar via the devices 114. The male or female plugs of the connectors may, optionally, be coupled to a coiled wire bundle 116 which may protect interiors 118 of the composite drill collars from drilling mud located within the borehole 12. The connectors 104 and/or the devices 114 may be made of the composite material to prevent the connectors 104 and/or the securing and connecting devices 114 from interfering with and/or degrading the measurements that may be collected by the wireline tools 106 and/or the sensors 108 within the interiors 118 of the composite drill collar. The coiled wire bundle 116 may be made of a conductive metallic material, such as, for example, ferrite, copper and/or the like.

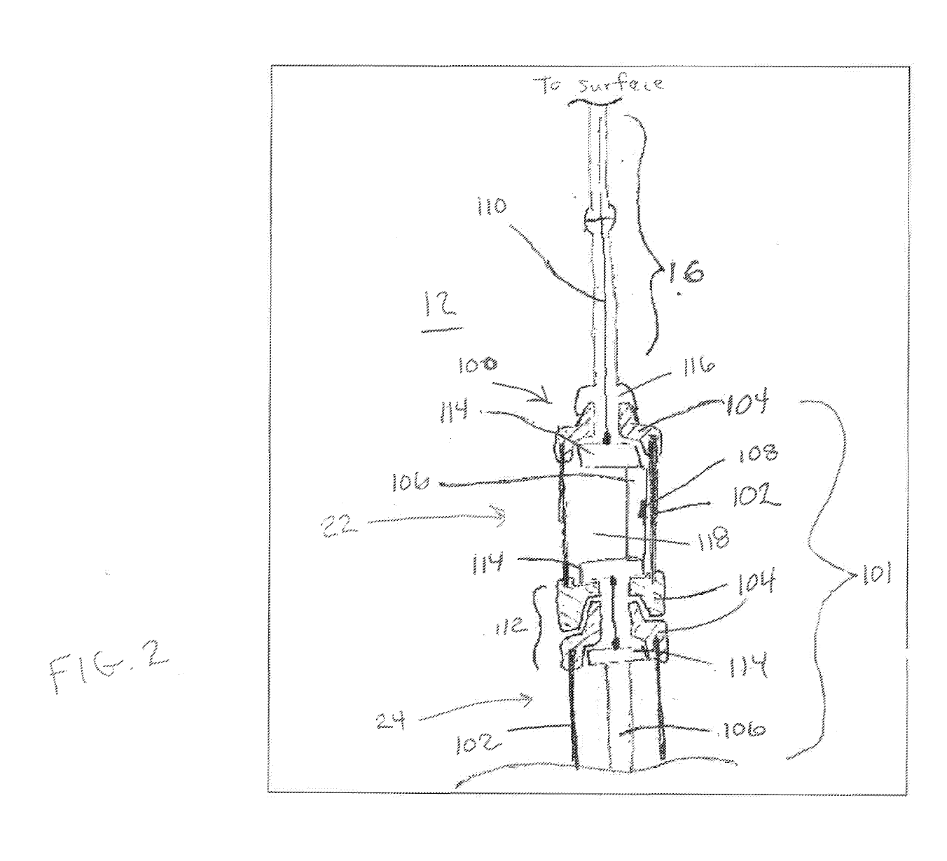

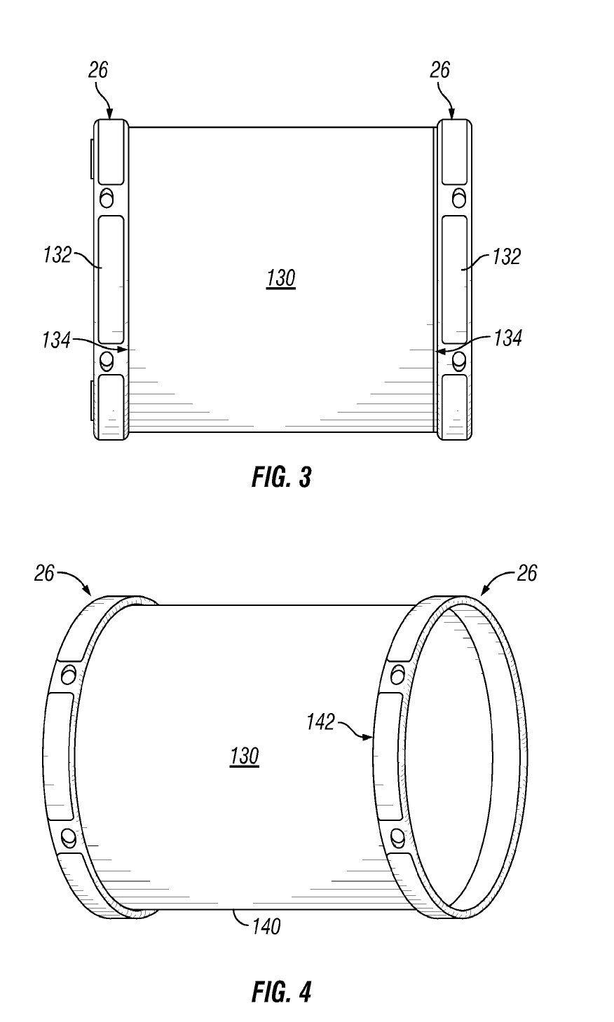

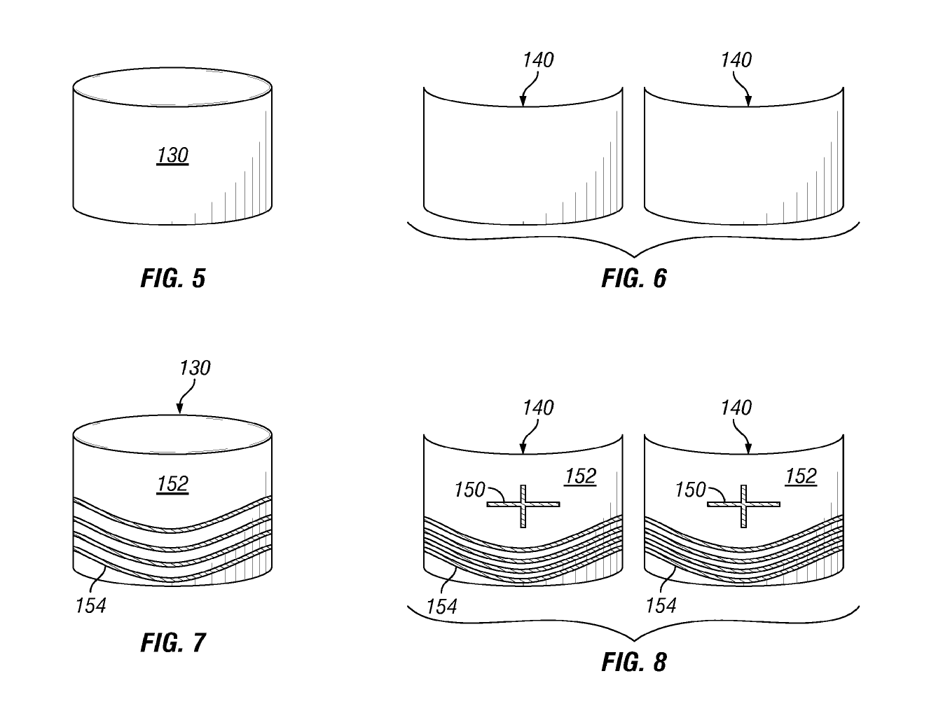

In embodiments, at least one of the downhole components 22, 32 may be a downhole tool which may have one or more sensors collecting one or measurements under tough downhole drilling conditions. For example, downhole component 26 may be a downhole tool which may have one or more sensors for collecting measurements associated with rock properties of the formation 14. To protect the sensor, the downhole component 26 may have a shielding element 130 made of the composite material (hereinafter “composite shield 130”) covering the sensors as shown in FIGS. 3-8. The composite shield may be attached to the downhole component 26 to package and protect the sensors of the downhole component 26. In embodiments, the downhole component 26 may be a composite collar which may be a shielding element for the sensors of the downhole component 26.

The composite shield 130 may be manufactured and/or produced as a hollow cylinder or sleeve made out of the composite material which may be positioned, slid over and/or on tops the sensors of the downhole component 26 as shown in FIGS. 3, 5 and 7. The composite shield may contact and/or abut a collar shoulder 132 of the downhole component 26. The collar shoulder 132 may have a threaded ring 134 which may be sized and adapted to receive the composite shield 132 such that the composite shield may lock with the threaded ring 134 as shown in FIG. 3. As a result, the composite shield 130 may be secured, connected and/or attached to the downhole component 26 via the threaded ring 134. Alternatively, the composite shield 130 may be in the form of a composite drill collar.

The sensors of the downhole component 26 may be protected by the composite shield 130. The composite shield 130 may be transparent or substantially transparent to measurements collected by the sensors. For example, the composite shield 130 may be transparent or substantially transparent to nuclear magnetic resonant, EM and/or acoustic field measurements. As a result, the composite shield 130 may not attenuate nuclear magnetic resonant, EM and/or acoustic field measurements and the one or more sensors may collect enhanced measurements through the composite shield 130.

In embodiments, the composite shield 130 may be manufactured and/or produced as a pair of half-shells 140 which may be locked on a collar 142 of the downhole component 26 as shown in FIGS. 4, 6 and 8. Each half-shell 140 may have threaded rings (not shown in the drawings) which may be overlapped at both ends of the pair of half-shells to connect, attach and/or secure the pair of half shells 140 of the composite shield 130 to each other and the downhole component 26. As a result, the composite shield 130 may be connected, attached and/or secured to the composite shield 130 for protecting the sensors of the downhole component 26.

In embodiments, the composite shield 130 may be utilized to filter one mode of radiation out from being collected by the sensors of the downhole component 26. For example, the composite shield 130 may have, for a z-directed coil (whereby the z-axis is along the downhole component axis), slots that may be parallel or substantially parallel to the axis of the downhole component 26. The coil (not shown in the drawings) may be wound around a circumference of the composite shield 130, and since any coil with more than one turn is helical in nature, the current may flow mostly in the x-y plane, but may also have a small component along the z-axis. A portion of current in the x-y plane may be equivalent to a magnetic dipole perpendicular to the x-y plane (i.e., in the z-axis). Superimposed on the magnetic dipole is a smaller dipole that may be caused by the component of the current along the z axis. The smaller latter dipole may be perpendicular (has no component along) or substantially perpendicular with respect to the z-axis. The large and small dipoles may be perpendicular or substantially perpendicular to each other; however, for a z-directed coil, only the large dipole may be desired and the small dipole may be parasitic or unwanted. The composite shield 130 may have axial slots which may allow radiation from the large dipole to pass while the shield attenuates the field from the small dipole. As such, the composite shield 130 may be viewed as having a filtering effect in favor of the large dipole.

In some applications, it is desirable to use the filtering effect of one or more slots 150 (hereinafter “slots 150”) in the composite shield 130 as shown in FIG. 8. The composite shield 130 may have a body 152 made of non-conductive and may have slots 150 which may be made of a conductive material. In embodiments, the slots 150 of the composite shield may be, for example, rods made of one or more metallic materials (hereinafter “metallic rods”) which may be embedded in the body of the composite shield 130 during the manufacturing of the composite shield 130. As a result, the composite shield 130 and the slots 150 in the form of metallic rods may have a filtering effect and/or may provide a protective effect for both the metal rods and the non-conductive body of the composite shield. The one or more metallic materials of the slots 150 may be made of ferrite, copper and/or the like. The present specification should not be limited to a specific embodiment of the metallic materials of the slots 150.

The composite shield 130 with the slots 150 may not be limited to the z-directed coils. For example, the slots 150 may be a tilted coil 154 with the body 152 of the composite shield 130 designed and/or configure to fit the tilted coil of the slots 150. For example, the composite shield 130 may be designed having a tilted coil 154 which may be tilted at 45 degree angle with respect to an axis of the downhole component 26 as shown in FIGS. 7 and 8. In embodiments, the slots 150 are distributed around the composite shield 130 at angles that may be, for the most part, not inline with the axis of the downhole component. As a result, the slots 150 may provide filtering effect and/or mechanical protection for the tilted coil 154. The body 152 of the composite shield 130 may be non-conductive while the slots 150 may be strips made of metal embedded into the body 152.

The composite shield 130 made of the composite material may not, degrade or substantially degrade measurements collected by the one or more sensors of downhole component 26 because the composite material has low conductivity or substantially low conductivity. The composite shield 130 may be manufactured in any shape required by a geometry of the downhole component 26. It should be understood that the present specification should not be deemed as limited to a specific shape and/or geometry of the composite shield 130 and/or the downhole component 26.

In embodiments, nuclear particles may be used in measurements collected by the one or more sensors of the downhole component 26, such as, for example, the naturally occurring radiation of rocks of the formation 14 to returning streams of thermalized neutrons. The composite shield 130 and/or the composite drill collar may provide significantly reduced attenuative properties to the nuclear particles both for (i) transmission from a source contained in the body 152 inside a center of the composite shield 130 and/or the composite drill collar and (ii) to the return path of the nuclear particles from the formation 14 back in to sensors housed within the composite shield 130 and/or the composite drill collar. As a result, reduced attenuative properties provide by the composite shield and/or the composite drill collar may substantially increase logging speeds and/or resolution from the detectors housed within the composite drill collar.

In embodiments, at least one of the downhole components 22, 32 may be a drill collar made of the composite material and having at least a LWD tool, a MWD tool, electronics and/or a sensor housed within a wall of the composite drill collar. For example, downhole component 28 may be composite drill collar 160 housing a LWD tool, a MWD tool, electronic circuitry and/or sensor 162 (hereinafter “the tool 162”) as shown in FIG. 9. The tool 162 may be configured and/or adapted to collect one or more measurements through the wall 164 of the composite drill collar 160. The tool 162 may be configured and/or adapted to perform, execute and/or complete one or more tasks associated with the wellsite system 10, the borehole 12, the formation 14, a drill string 16, the BHA 18 and/or the drill bit 20. The tool 162 may have or be programmed with logic for performing the one or more tasks and/or collecting the one or more measurements. During manufacturing of the composite drill collar 160, the composite material may be built and/or formed around the tool 162 such that the tool 162 may be housed and/or located within the wall 164 of the composite drill collar 16.

The composite drill collar 160 and/or the tool 162 may be positioned between other downhole components within the BHA 18, such as, for example, between the downhole components 26 and 30 as shown in FIG. 9. The tool 162 of the composite drill collar 160 may be capable of transmitting wireless communication through the wall 164 of the composite drill collar 160 because the composite material of the composite drill collar 160 may be conductively and/or magnetically transparent to the tool 162 based on the non-conductive, substantially non-conductive, and non-metallic properties of the composite material. As a result, the tool 162 may wirelessly transmit and/or receive data, electronic instructions and/or electrical power and/or energy (hereinafter “power”) while the BHA 18 may be located within the borehole 12 and/or when the tool 162 may be at the surface 11. In embodiments, the wireless data may include wireless telemetry data and/or one or more measurements collected by the downhole components 22, 32 and/or the tool 162. Moreover, the tool 162 may, upon receiving the wireless power, execute the logic to perform the one or more tasks and/or to collect the one or more measurements. The wireless electronic instructions may relate to one or more tasks which may be performed by the tool 162 within the borehole 12 and/or the formation 14. After receiving wireless power, the tool 162 may be actuated by the wireless power and may collect the one or more measurements and/or perform the one or more tasks.

The transparency of the composite drill collar 160 with respect to the tool 162 allows for transmitting and receiving of wireless data, electronic instruction and/or power from the tool 162 without the need for and use of a read-out port provided in the composite drill collar 160. Inclusion of the read-out port within the composite drill collar 160 may weaken the structural integrity of the composite drill collar 160 and should be avoided when possible. By allowing for wireless communication and/or transmission of data, electronic instructions and/or power to and from the tool 162 through the wall 164 of the composite drill collar 160, establishing and/or maintaining a wired connection between the tool 162 and a computer (not shown in the drawings) and/or a retrievable mandrel 166 (hereinafter “mandrel 166”) may be avoided. Establishing and maintaining a wired connection between the tool 162 and computer and/or the mandrel 166 may be cumbersome, inconvenient and/or time consuming and should also be avoided when possible.

The tool 162 housed within the composite drill collar 160 may perform one or more tasks and/or collect one or more enhanced measurements based on the transparency of the composite drill collar 160 with respect to the tool 162. Additionally, the transparency of the composite drill collar 160 with respect to the tool 162 may improve efficiency and/or prevent negatively affecting and/or degrading the one or more tasks and/or measurements, such as, for example, resistivity measurements that may be collected by the tool 162. For nuclear measurements, the non-conductive or substantially non-conductive composite drill collar 160 protects the tool 162 without shielding the tool 162 from radiation returning from the formation 14.

In embodiments, the mandrel 166 may be connected to the wireline 110 and lowered into and/or positioned within the borehole 12 and/or the BHA 18. The mandrel 166 may be centrally inserted into and/or positioned within an interior 168 of the composite drill collar 160. The mandrel 166 may have one or more sensors, electronics and batteries (not shown in the figures). In embodiments, the mandrel 166 may be incorporated into a wireline tool or may be a wireline tool. The mandrel 166 and/or the one or more sensors of the mandrel 166 may be configured and/or adapted to collect one or more measurements related to characteristics and/or properties associated with the borehole 12, the formation 14, the drill string 16, the BHA 18 and/or the drill bit 20. The mandrel 166 and/or the one or more sensors of the mandrel 166 may collect the one or more measurements through the wall 164 of the composite drill collar 160 because the wall 164 may be transparent with respect to the mandrel 166 and/or the one or more sensors of the mandrel 166.

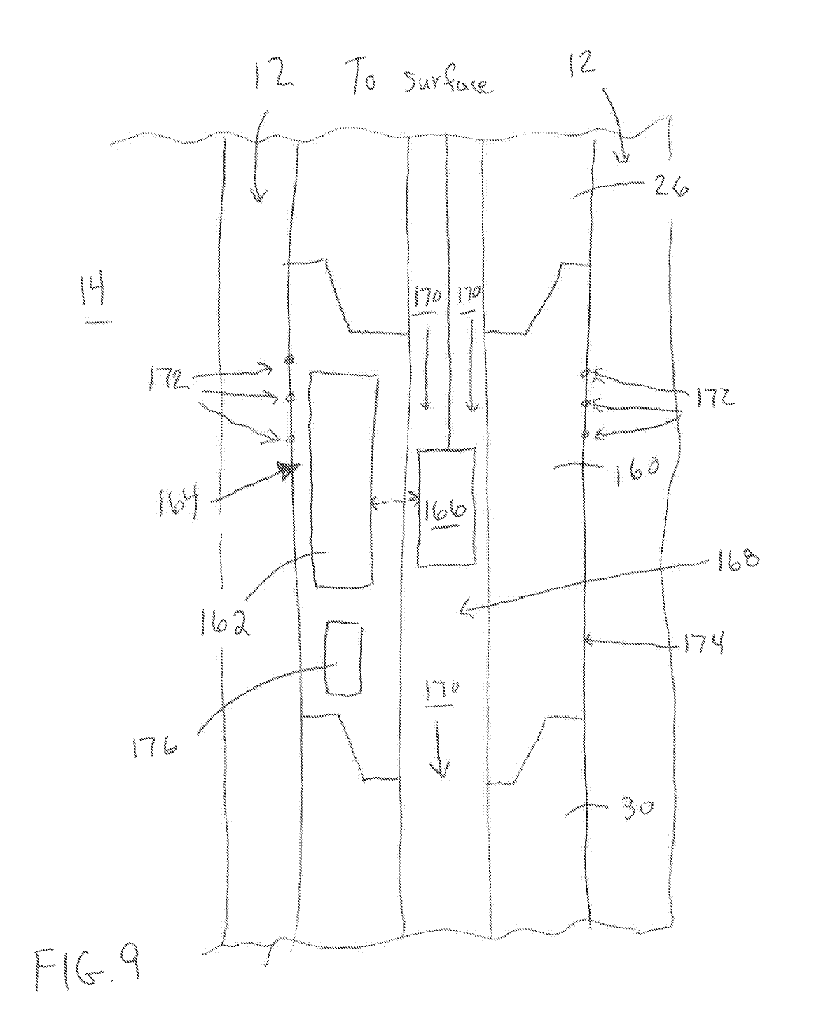

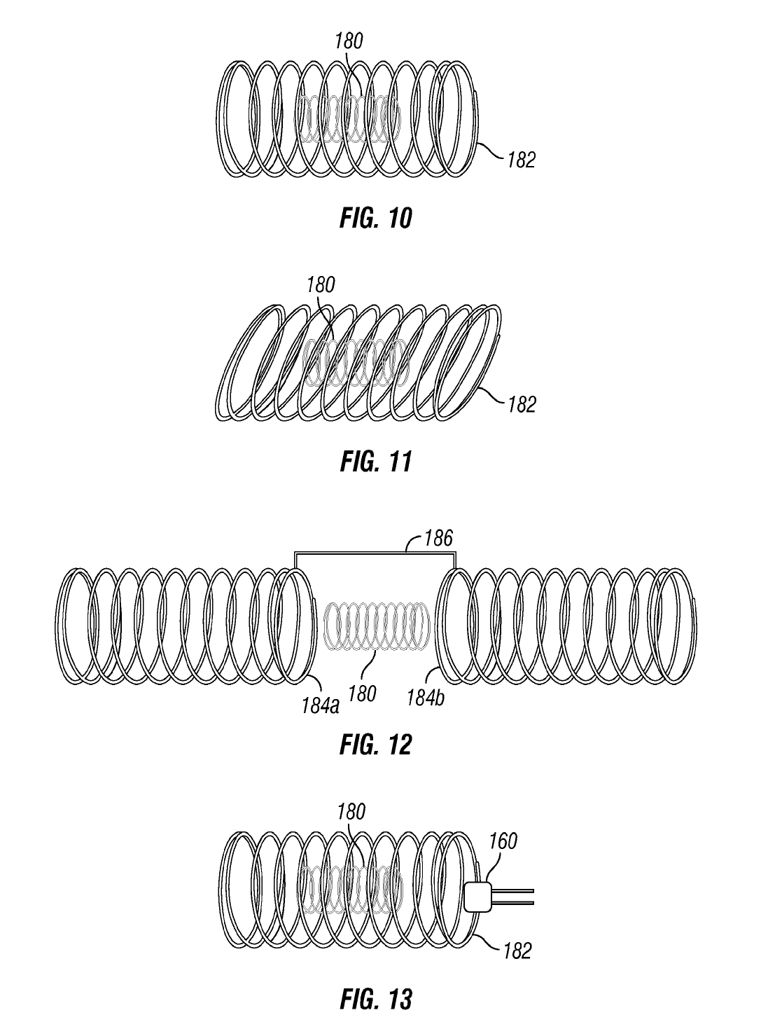

The mandrel 166 may have one or more coils and/or antennas 180 (hereinafter “inner coils 180”) as shown in FIGS. 10-13. The mandrel 166 may be configured and/or adapted to transmit and/or receive at least one EM signal, such as, for example, at least one radio frequency (hereinafter “RF”) signal via the inner coils. As a result, the mandrel 166 may be configured and/or adapted to transmit and/or receive wireless communication of data, electronic instructions and/or power via the inner coils 180. The mandrel 166 may be scaled and/or sized small enough so as to leave available space within the interior 168 of the composite drill collar 160 for necessary fluid-flows of drilling fluids 170 through the interior 168 of the composite drill collar 160. As a result, an annular flow path for the drilling fluids may be providing around the mandrel 166 and an inside of the wall 164 of the composite drill collar 160.

The tool 162 may have one or more outer coils and/or antennas 182 (hereinafter “outer coils 182”) as shown in FIGS. 10-13 which may be configured and/or adapted to transmit and/or receive wireless data, electronic instructions and/or power via at least one signal, for example, EM signals, such as, RF signals. In embodiments, the outer coils 182 may be embedded into the walls 164 and/or other portions of the composite drill collar 160 during the manufacturing of the composite drill collar 160. The inner coils 180 of the mandrel and/or the outer coils 182 of the tool 162 and/or the composite drill collar 160, respectively may be made of one or more metallic materials, such as, for example, ferrite, copper and/or the like. It should be understood that the present specification should not be deemed limited to a specific embodiment of the metallic material of the inner coils 180 and/or the outer coils 182. Moreover, it should be understood that the present specification should not be deemed as limited to a specific embodiment of the at least one signal for transmitting and/or receiving wireless data, electronic instructions and/or power.

In embodiments, the wireless communication and/or transmission of data, electronic instructions and/or power between the tool 162 and the computer and/or the mandrel 166 may be carried out by induction, resonant inductive coupling, inductive power transfer, electrodynamic inductive effect, radio wave frequencies, microwave frequencies or transmissions, laser beams and/or evanescent wave coupling, as known in the art. In embodiments, the wireless communication between the tool 162 and the computer and/or the mandrel 166 may require the tool 162 and the computer and/or the mandrel 166 to be in a line of sight with each other, directly adjacent to each other, and/or in a close proximity to each other.

The wireless communication may be based on a strong coupling between electromagnetic resonant objects, such as, the inner coils 180 of the mandrel 166 and the outer coils 182 of the tool 162 to wirelessly transfer the data, the electronic instructions and/or the power. The tool 162 and the mandrel 166 may contain one or more magnetic loop antennas critically tuned to the same or substantially the same frequency. In embodiments, the inner coils 180 of the mandrel and the outer coils 182 of the tool 162 may form the one or more magnetic look antennas which may be critically tuned to the same or substantially the same frequency. As a result of the magnetic loop antennas being tuned to the same or substantially the same frequency, strong-coupled resonances may be achieved between the tool 162 and the mandrel 166 to achieve high wireless communication and/or power-transmission efficiency between the tool 162 and the mandrel 166. Moreover, transmission of data and/or electronic instructions may be embedded into and/or included with high wireless power transmissions between the tool 162 and the mandrel 166. In embodiments, the wireless data, electronic instructions and/or power transfer technology may be, for example, WiTricity or a wireless resonant energy link as known in the art.

The non-conductive or substantially non-conductive composite drill collar 160 may not load the outer coils 182 of the tool 162 and/or the composite drill collar 160 which may improve and/or enhance wireless communication properties of the tool 162, the composite drill collar 160 and/or the mandrel 166. Data, electronic instructions and/or power may be wirelessly transmitted to and/or received by the composite drill collar 160, the tool 162, the mandrel 166 and/or the computer. In embodiments, data, electronic instructions and/or power may be wirelessly transmitted between the mandrel 166 and the tool 162 and/or the composite drill collar 160 via the inner coils 180 of the mandrel and the outer coils 182 of the tool 162, respectively. The wireless data that may be wirelessly communicated and/or transmitted from the mandrel 166 to the tool 162 may include telemetry data and/or the one or more measurements which may be collected by the mandrel 166 and/or the one or more sensors of the mandrel 166. In embodiments, the wireless communication and/or transmission of data, electronic instructions and/or power between the tool 162 and/or the composite drill collar 160 and the computer and/or the mandrel 166 may occur within the borehole as shown in FIG. 9. Alternatively, the wireless communication and/or transmission of data, electronic instructions and/or power between the computer and the tool 162 and/or the composite drill collar may occur at the surface 11 after the tool 162 and drill collar 160 have been pulled from the borehole 12.

Upon receiving the wireless electrical instructions and/or power from the mandrel 166, the tool 162 may be actuated and/or the logic may be executed to collect the one or more measurements and/or perform the one or more tasks. As a result, the mandrel 166 may control when and/or where one or more tasks may be performed, executed and/or completed by the tool 162. The mandrel 166 may wirelessly provide necessary wireless electronic instructions and/or power to the tool 162 for performing, executing and/or completing the one or more tasks and/or collecting the one or more measurements. For example, data and/or electronic instructions wirelessly communicated to the tool 162 from the mandrel 166 may be, for example, data and/or electronic instructions relating to setup, programming and/or operation of the tool 162 and/or instructions to perform an inventor of any downhole components located within the range of the at least one signal. The one or more tasks performable and/or the one or more measurements collectable by the tool 162 may be any downhole task and/or measurement, respectively, as know to one of ordinary skill in the art.

In embodiments, the composite drill collar 160 and/or the tool 162 may be electrically connected to a power source (not shown in the drawings) which may be located locally or remotely with respect to the composite drill collar 160. The composite drill collar 160 and/or the tool 162 may transmit wireless power from the power source to the mandrel 166 via the outer coils 182 of the composite drill collar 160 and/or the tool 162 and the inner coils 180 of the mandrel 166. Alternatively, the mandrel 166 may be electrically connected to a power source (not shown in the drawings) which may be located locally or remotely with respect to the mandrel 166. The mandrel 166 may transmit wireless power from the power source to the composite drill collar 160 and/or the tool 162 via the inner coils 180 of the mandrel and the outer coils 182 of the composite drill collar 160 and/or the tool 162.

In embodiments, the outer coils 182 may be embedded in the composite drill collar 160 and may be configured to filter and/or shape the at least one EM signal that may be produced and/or transmitted by the inner coil 180 of the mandrel 166. By filtering and/or shaping at least one EM signal of the inner coil 180, a signal strength and/or intensity of the at least one EM signal may be substantially increased which may increase an efficiency of the wireless communication and/or transmission of data, electrical instructions and/or power between the inner coil 180 and the outer coil. The inner coils 180 and the outer coils 182 may be configured to allow for wireless communication and/or transmission of data, electronic instructions, power and/or telemetry between the inner coils 180 and outer coils 182 without requiring holes, feedthroughs and/or wires for the composite drill collar 160 and/or the mandrel 166.

FIG. 10 illustrates the inner coil 180 embedded in the mandrel 166 which may be incorporated into, for example, a wireline tool centrally located within the composite drill collar 160. FIG. 11 shows an embodiment where the outer coils 182 of the composite drill collar 160 and the inner coils 180 of the mandrel are tilted with respect to each other. The outer coil 182 of the composite drill collar 160 may act as a shield, filter or resonator to the inner coil 180 mounted on the mandrel 166. To enhance field focusing of the inner coil 180 of the mandrel 166, more than one outer coils 184a, 184b may be separately embedded in the composite drill collar 160 as shown in FIG. 11. Wireless data, electronic instructions and/or power may be transmitted between inner coil 180 of the mandrel and the outer coils 184a, 184b which may be made of a conductive metallic material, such as, for example ferrite, copper and/or the like. The present specification should not be deemed as limited to a specific number of outer coils that may be embedded in the composite drill collar 160.

In embodiments, strips (not shown in the drawings) of metallic material, such as, ferrite may be embedded in the composite drill collar 160. The strips embedded in the composite drill collar may focus the one or more signals transmitted from the inner coil 180 of the mandrel 166 to the tool 162.

In embodiments, the outer coils 182 of the composite drill collar 160 may receive wireless power and/or bidirectional telemetry from the inner coils 180 of the mandrel 166 and/or may direct the wireless power and telemetry through circuitry to a sensor of, for example, the tool 162 as shown in FIG. 13. The inner coils 180 and the outer coils 182 (hereinafter collectively known as “the coils 180, 182”) may operate at a different frequency and/or may have different winding arrangements, such as, for example, a transverse arrangement as opposed to coaxial. As a result, the transverse arrangement may allow directional changes in the EM field of the coils 180, 182.

Interactions between the coils 180, 182 may be improved if a layer (not shown in the drawings) may be positioned between the coils 180, 182 which may contain materials with high magnetic permeability such as, for example, ferrite. By placing the layer between the coils 180, 182, the resulting structure may be electrically equivalent to a transformer whose efficiency depends on the magnetic permeability of the material carrying the magnetic flux from, for example, the inner coils 180 to the outer coils 182. The materials of the layer may be any high magnetic permeable material as known to one of ordinary skill in the art.

In embodiments, the outer coils 184a, 184b may be physically connected by a connecting wire 186 which may provide maximum efficiency for wireless communication and transmission of data, wireless instructions and/or power between the inner coils 180 and the outer coils 184a, 184b as shown in FIG. 12. The connecting wire 186 may be made of a conductive metallic material, such as ferrite, copper and/or the like. The composite drill collar may be made and/or grown around the outer coils 184a, 184b and the wire 186. A result, the connecting wire 186 may be embedded in the composite drill collar 160 without any loss of mechanical integrity of the composite drill collar 160. The conductive material of the inner coils 180, the outer coils 182, the outer coils 184a, 184b and/or the connecting wire 186 may be made of any conductive material as known to one of ordinary skill in the art.

Another advantage of the non-conductive composite drill collar may be antenna efficiency. In embodiments, antenna coils 172 may be wound around an outside perimeter 174 of the composite drill collar 160 either as tilted antennas or as axial antennas as shown in FIG. 9. A groove (not shown in the drawings) may be cutting and/or formed in the outside perimeter 174 to house and/or secure the antenna coils 172. The groove may not have a great depth with respect to a thickness of wall 164 of the composite drill collar 160 because the depth of the groove may adversely effect the mechanical integrity of the composite drill collar 160 which may be a priority over the depth of the groove. However, the depth of groove may be an important parameter controlling the efficiency of the antenna coils 172. When a metallic object is brought close to a flowing current, an Eddy current is induced in the metallic object which contracts the original current (flows in opposite direction to it). In the limit when the conducive object touches the current carrying structure, the two currents cancel each other and the antenna is shorted. As the conductive object is moved away from the coil its effect is reduced.

With the composite drill collar 160 made of non-conductive material, the intensity of the Eddy current may be proportional to the conductivity of the composite drill collar 160 which may be very low. As a result, the antenna coils 172 may become more efficient to the extent that the closest metallic object may be farther away than case of a metallic drill collar.

Electrical components, such as, for example, the mandrel 166 and the flowing drilling fluids, which may be conductive, in the interior 168 of the composite drill collar 160 may affect the antenna coils 172. As a result, the electrical components may be shielded by a layer (not shown in the drawings) of metal to create a constant internal environment for the antenna coils 172. The metal layer may affect loading the antenna coils 172 which may be proportionally less than that of a metal drill collar 160. Additionally, any necessary feed throughs for the antenna coils 172 may be made an integral part of the composite drill collar. Moreover, the wire of the antenna coils 172 may go directly through the wall 164 of the composite drill collar 160 because the collar may be made after the coil without the no need to drill any holes or to pressure seal using O-rings.

In embodiments, at least one of the drill pipes 17, the downhole components 22, 32 and/or the uphole components 34 may be made of the composite material and may have a RF identified tag 176 (hereinafter “RFID tag 176”) embedded in the composite material as shown in FIG. 9. For example, the composite drill collar 160 may have the RFID tag 176 which may be housed in the wall 164 of the composite drill collar 160 during the manufacture of the composite drill collar 160. The RFID tag 176 may be configured and/or adapted to store and/or process information associated with, for example, the composite drill collar 160. Additionally, the RFID tag 176 may having an antenna (not shown in the drawings) configured and/or adapted for receiving and/or transmitting one or more RF signals The information stored and/or processed by the RFID tag 176 may be information related to, for example, the specifications of the composite drill collar 160. The information stored and/or processed by the RFID tag 176 may be any information as known to one of ordinary skilling the art that may relate to and/or be relevant to the drill pipe, downhole component and/or uphole component which may house the RFID tag 176.

A RFID reader (not shown in the drawings) may be utilized to access the information that may be stored by the RFID 176 via one or more RF signals. For example, the RFID reader may access the information associated with the composite drill collar 160 that may be stored by the RFID tag 176 via the one or more RF signals. As a result, the specifications of the composite drill collar 160 may be quickly and easily identified by the user of the RFID reader. Additionally, the RFID reader, when used multiple RFID tags may identified which assets may be deployed in the borehole 12 or location and/or may track the functionality of identically looking downhole components. In some cases, multiple different tools with different functionalities may be protected with the same type of composite drill collar and/or composite material which may make it difficult to identify the multiple different tools without the use of RFID tags. In embodiments, the RFID reader may be a hand held device or may be located on, for example, a floor of a drilling rig (not shown in the drawings). The RFID reader may be any RFID reader as known to one of ordinary skill in the art.

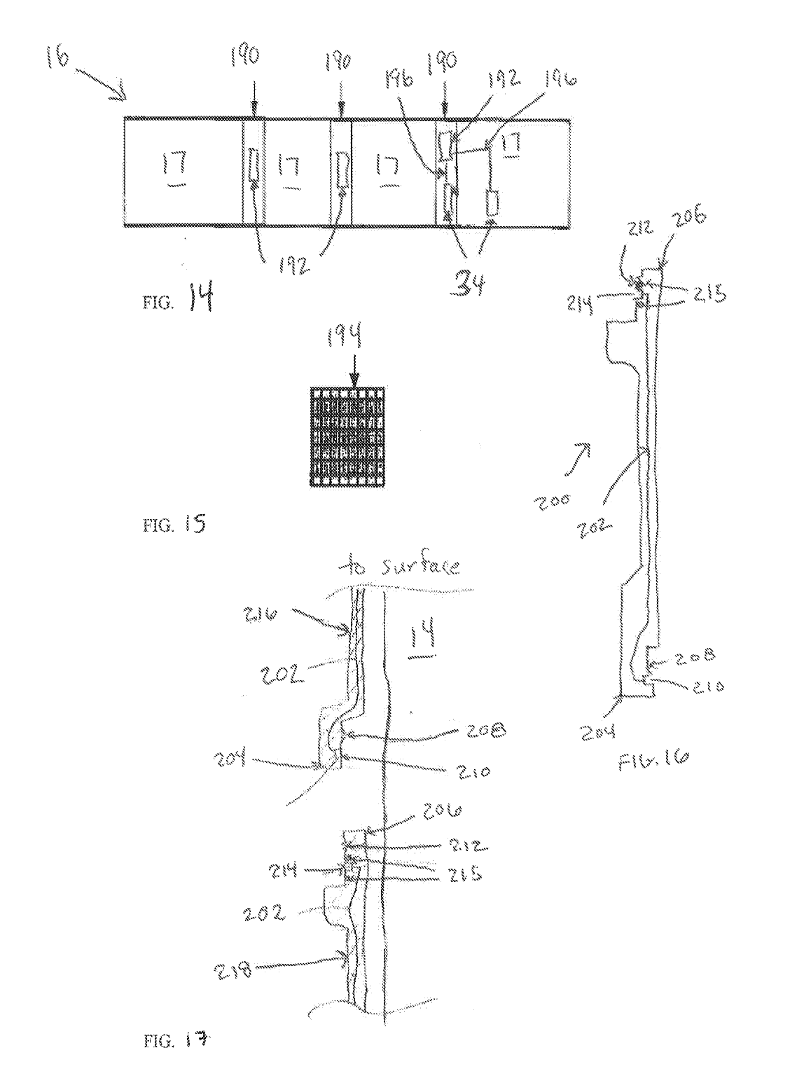

In embodiments, one or more composite short pipes 190 (hereinafter “composite pipes 190”) may be incorporated into the drill string 16 as shown in FIG. 14. Each of the composite pipes 190 may be located between and/or connected to two separate drill pipes 17. The composite pipes 190 may be made of the composite material. One or more energy harvesting devices 192 (hereinafter “devices 192”) may be embedded within the composite pipes 190 during manufacture of the composite pipes 190. The devices 192 may be extensionally and/or radially deployed and/or embedded within the composite pipes 190. The devices 192 may be, for example, energy harvesting piezoelectric strips 194 as shown in FIG. 15, energy harvesting electromagnetic devices and/or the like. The devices 192 may be any number of and/or any type of energy harvesting devices suitable for embedding into the composite material of the composite pipes 190.

The devices 192 of the composite pipes 190 may be configured and/or adapted to convert one or more deformations of the drill string 16 into electrical power which may be utilized to power one or more uphole components 34 and/or downhole components 22, 32. The deformation of the drill string 16 may be a result of stress on the drill string 16, such as, for example, Hoop stresses, extensional motions and/or the like. The one or more deformations may occur at and/or within the one or more drill pipes 17 and/or at the composite pipes 190. It should be understood that the present specification is not limited to a specific embodiment of the one or more deformations of the drill string 16.

The devices 192 may be electrically connected to one or more uphole components 34 and/or downhole components 22, 32 to provide and/or supply harvested energy and/or the electrical power to the downhole components 22, 32 the uphole components 34, such as, for example, low-power repeaters or sensors via wires 196. The one or more uphole components 34 may be embedded within the composite pipes 190 and/or located within one of the drill pipes 17 as shown in FIG. 14. For example, one or more energy harvesting piezoelectric strips 194 may be embedded within the composite pipes 190, may convert Hoop stresses and extensional motions of the drill string 16 into electrical power and may supply the electrical power to the uphole components 34 via the wires 196. In embodiments, a length of the composite pipes 190 may be selected to induce a system resonance at a desired frequency as known to one of ordinary skill in the art.

In embodiments, at least one or more composite housings 200 (hereinafter “composite housings 200”) of at least one of the drill pipes 17, the downhole components 22, 32, and/or the uphole component 34 may be made of the composite material as shown in FIG. 16. A flow line 202 may be embedded in the composite housing 200 during the manufacture of the composite housing 200. The flow line may extend along a length of the composite housings 200 from a first end 204 of the composite housings 200 to a second end 206 of the composite housings 200 which may be located opposite to the first end 204. A diameter and/or a radius of the flow line 202 may be any diameter and/or radius as known to one of ordinary skill in the art.

The flow line 202 may be sized, configured and/or adapted to permit one or more clean fluids to flow across the length of the composite housing 200. As a result, the one or more clean fluids may be distributed to at least one of the BHA 18, the downhole components 22, 32 and/or the uphole components 34. The clean fluids provided via the flow line 202 may provide, for example, hydraulic power to at least one of the BHA 18, the downhole components 22, 32 and/or the uphole components 34. For example, hydraulic fluids may be provided to, for example, a power drive stirring tool and/or to a piston of a downhole tool.

The first end 204 of composite housings 200 may have first threading 208 and a first annulus 210, and second end 206 of the composite housings 200 may have second threading 212 and a second annulus 214. The first threading 208 at the first end 204 may correspond to the second threading 212 at the second end 206. The second end 206 of the composite housings 200 may have one or more sealing elements 215 for providing a complete seal around the second annulus 214. For example, the sealing elements 215 may be a mechanical gasket, O-rings and/or the like. The sealing elements 215 may be any sealing elements as known to one or ordinary skill in the art.

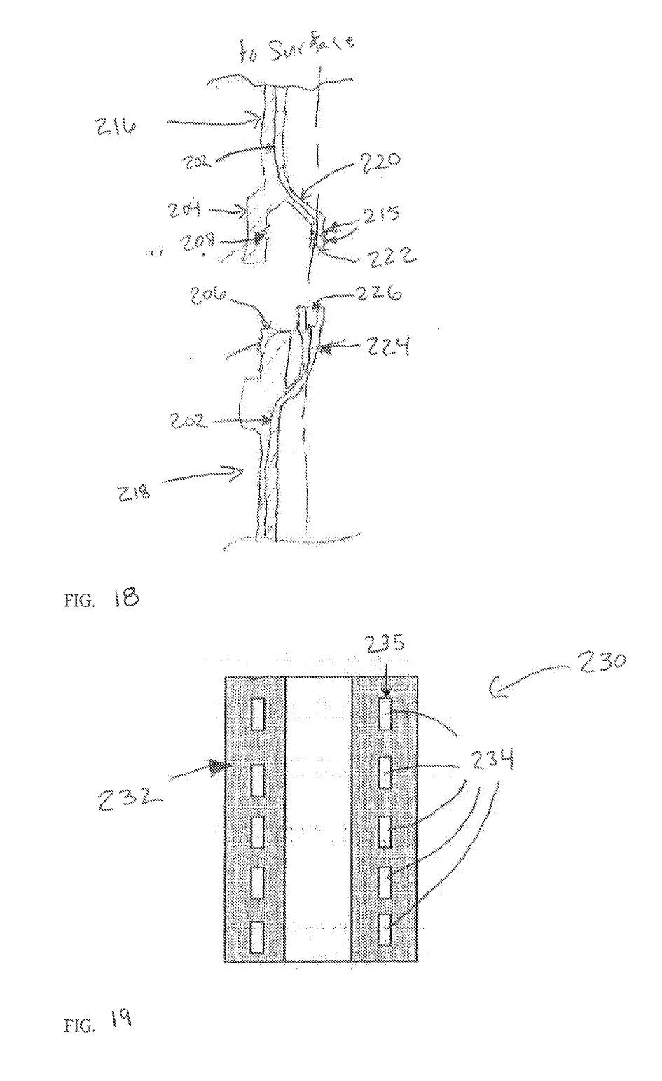

The first treading 208 of the first end 204 of a first composite housing 216 may be threaded, secured and/or connected to the second threads 212 of the second end 206 of a second composite housing 218 as shown in FIG. 17. The first and second composite housings 216, 218 may be secured together and the first annulus 210 at the first end 204 of the first composite housing 216 may be aligned with or substantially aligned with the second annulus 214 of the second composite housing 218. As a result, the first annulus 210 and flow line 202 of the first composite housing 216 may be in fluid communication with the second annulus 214 and/or the flow line 202 of the second composite housing 218. Moreover, the fluid communication between first annulus 210 and the second annulus 214 may be sealed by the sealing elements 215 at the second end 206 of the second composite housing 218.

In embodiments, the first end 204 of the first composite housing 216 may have a first arm 220 with a male connector 222 which may extend outward with respect to the first threading 208 of the first composite housing 216 as shown in FIG. 18. The flow line 202 of the first composite housing 216 may extend up to and/or terminate at the male connector 222. The second end 206 of the second composite housing 218 may have a second arm 224 with a female connector 226 which may extend outward with respect to the second threading 212 of the second composite housing 218. The flow line 202 of the second composite housing 218 may extend up to and/or terminate at the female connector 222. The male connector 222 may have the securing elements 215 to provide a seal when the male connector 222 may be inserted into the female connector 226.

The first and second composite housings 216, 218 may be attached and/or secured together via the first and second threading 208, 212 and the male connector 222 of the first composite housing 216 may be mated with and/or located within the female connector 226 of the second composite housing 218. As a result, the flow line 202 of the first composite housing 216 may be in fluid communication with the flow line 202 of the second composite housing 218. Moreover, the fluid communication between first annulus 210 and the second annulus 214 may be sealed by the sealing elements 215 of the male connector 222.

In embodiments, at least one of the downhole components 22, 32 may be connected to or may be an acoustic attenuator 230 which may be made of the composite material (hereinafter “composite attenuator 230”) as shown in FIGS. 19-21. For example, the composite attenuator may be connected to a LWD tool and/or a wireline logging tool. In embodiments, the acoustic attenuator 230 may be located between two downhole tools. For example, the composite attenuator 230 may located and/or positioned between two wireline logging tools or between the downhole components 22, 24 of FIG. 1. The composite attenuator 230 may be connected to and/or used with any downhole component as known to one of ordinary skill in the art.

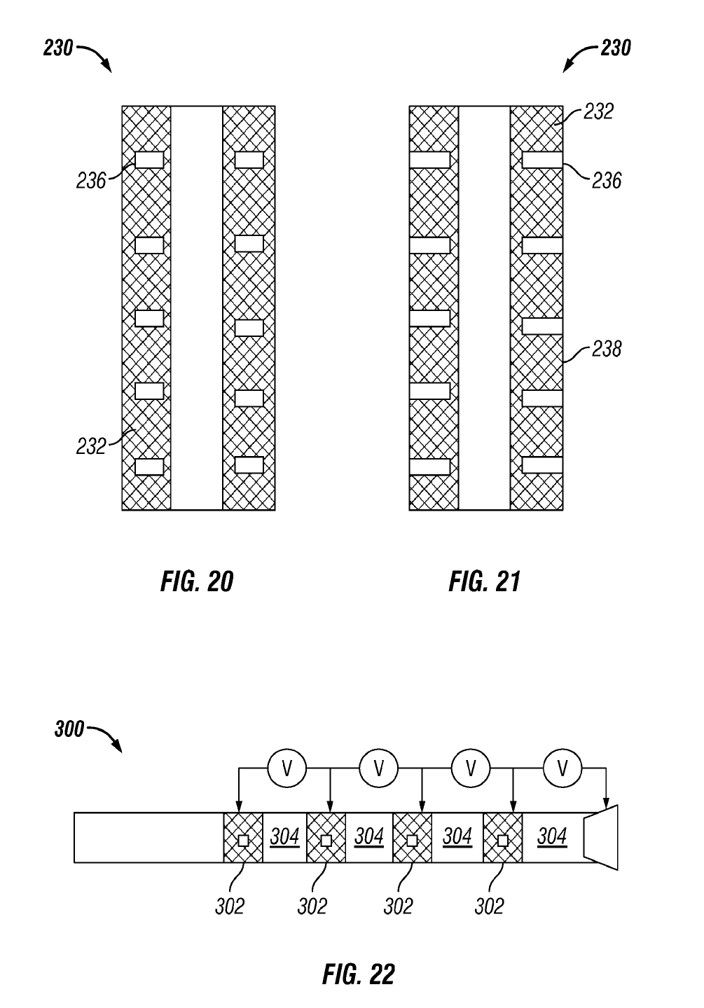

The composite attenuator 230 may have one or more acoustic impedance elements which may have been embedded within a wall 232 of the composite attenuator 230 during manufacture of the composite attenuator. In embodiments, the acoustic impedance elements may be one or more air gaps 234 (hereinafter “air gaps 234”) as shown in FIG. 19 and/or one or more metallic rings 236 (hereinafter “metallic rings 236”) as shown in FIGS. 20 and 21. The air gaps 234 and/or the metallic rings 236 may be embedded within the wall 232 of the composite attenuator 230 during manufacture of the composite attenuator 230. It should be understood that the present specification is not deemed limited to the specific embodiments of the acoustic impedance elements which may be embedded in the composite attenuator 230.

The air gaps 234 and/or metallic rings 236 of the composite attenuator 230 may be configured to and/or adapted to break, terminate or substantially terminate a wave propagation path which may have entered the wall 232 of the composite attenuator 230 and/or may be propagating and/or moving through the composite attenuator 230. Alternatively, a pattern of the air gaps 234 and/or the metallic rings 236 within the wall 232 of the composite attenuator 230 may be designed and/or manufactured to improve wave propagation attenuation across the composite attenuator 230 as known to one of ordinary skill in the art.

In order to provide the air gaps 234 within the wall 232 of the composite attenuator 230, one or more hollow metallic cubes 235 may be embedded within the wall 232 of the composite attenuator 230 during the manufacture of the composite attenuator 230. The metallic rings 236 may be, for example, one or more metal rings having an acoustic impedance that may be higher than an acoustic impedance of the composite material of the composite attenuator 230 which may have a low impedance property. The air gaps 234, metallic cubes 235 and/or the metallic rings 236 may be located and/or embedded inside the wall 232 of the composite attenuator 230 as shown in FIGS. 19 and 20. Alternatively, the metallic cubes 235 and/or the metallic rings 236 may be embedded such that an edge or a side of the metallic cubes 235 and/or the metallic rings 236 extend to and/or terminate at an outside surface 238 of the wall 232 of the composite attenuator 230 as shown in FIG. 21.

In embodiments, at least one of the downhole components 22, 32 may be configured to and/or adapted to transmit one or more signals and at least another of the downhole components 22, 32 may be configured and/or adapted to receive the one or more signals, such as, for example, EM signals. For example, the downhole component 26 may have one or more transmitter coils 36 for transmitting one or more EM signals, and the downhole component 30 may have one or more receiver coils 38 for receiving the one or more EM signals that may be transmitted by the one or more transmitting coils 36 the downhole component 26 as shown in FIG. 1. The downhole component 28 may be located between downhole components 26, 30 and may be an electrical gaps isolator collar which may be configured and/or adapted to electrically isolate the downhole components 26, 30 from each other. The electrical gaps isolator collar of the downhole component 28 may be made of the composite material (hereinafter “composite isolator collar”) which may be non-conductive and/or substantially non-conductive to provide an isolation gap between the downhole components 26, 30. As a result, the composite isolator collar may be electromagnetically transparent with respect to the transmitter coils 36 and the receiver coils 38 of the downhole components 26, 30, respectively. Moreover, the composite isolator collar may insulate a first position on the BHA 18, for example, downhole component 26, from a second position on the BHA 18, for example, downhole component 30.

The composite isolator collar may electrically isolate and/or insulate the one or more transmitter coils 36 of the downhole component 26 from the one or more receiver coils 38 of the downhole component 30. The composite isolator collar may prevent the one or more signals transmitted by the downhole component 26 from passing through the composite isolator collar of the downhole component 28 and into the downhole component 30. As a result, the one or more signals transmitted by the downhole component 26 may be radiated into the formation 14 by the composite isolator collar whereby the one or more signals may penetrate the formation 14 and/or be received and/or detected by the receiving coils 38 of the downhole component 30 as shown in FIG. 1. The downhole component 30 may collect one or more measurements related to characteristics and/or properties associated with the formation 14 based on the one or more signals received from the downhole component 26 and/or radiated by the composite isolator collar. As a result, the electromagnetically transparent composite material of the composite isolator collar may substantially improve efficiency and/or accuracy of the one or more measurements that may be collected by electromagnetic telemetry tools, anti-collision electromagnetic tools, electromagnetic look ahead tools and/or other known electromagnetic tools. Further, the composite isolator collar of the downhole component 28 may be electrically and mechanically stronger than conventional metallic electrical isolator subs. As a result, the composite isolator collar may increase reliability and/or may lower costs associated with manufacturing electromagnetic tools.

FIG. 22 shows a composite drill collar 300 which may be made of the non-conductive or substantially non-conductive composite material. In embodiments, at least one composite drill collar 300 may be incorporated in the BHA 18 of the wellsite system 10. One or more electrodes or sensors 302 (hereinafter “sensors 302”) may be embedded into the composite material of the composite drill collar 300 during manufacturing of the composite drill collar 300. The one or more electrodes 302 may be modular and/or azimuthal electrodes mounted on the composite drill collar 300. As a result, at least one large array of electrodes 302 which may be azimuthally mounted on the composite drill collar 300 may be provide for improved vertical and azimuthal measurement resolution. Any number of electrodes 302 may be embedded into the composite drill collar 300 and/or incorporated into the large array of electrodes 302 as known to one of ordinary skill in the art. It should be understood that the present specification should not be deemed as limited to specific embodiments of the electrodes 302 which may be suitable embedded into the composite drill collar 300.

Isolating portions 304 of the non-conductive or substantially non-conductive composite material may be located between two adjacently located electrodes 302. As a result, each of the electrodes 302 may be electrically isolated from each other via the isolating portions 304 of the composite material. The electrically isolated electrodes 302 may be utilized to collect one or more measurements relating one or more characteristics and/or properties associated with the borehole 12, the formation 14, the drill string 16, the BHA 18, the drill bit 20 and/or drilling fluid 170. For example, the electrically isolated electrodes 302 may be utilized for collecting streaming potential measurements having applications in LWD operations and/or permanent monitoring for fluid front measurement. The measurements collected by the one or more electrodes 302 may be any type of measurements as known to one of ordinary skill in the art.

The composite drill collar 300 having one or more electrodes 302 may be arranged along the BHA 18 at a position near and/or adjacent to the drilling bit 20, such as, for example, on a near-bit tool. As a result, the composite drill collar 300, during drilling, may collect one or more measurements associated with, for example, formation pressure of the formation 14. In embodiments, the one or more electrodes 302 may be permanent electrodes for fluid front monitoring application. As a result, the one or more electrodes 302 may be mounted on the composite drill collar 300 such that the one or more electrodes 302 may collect measurements associated with a reservoir of the borehole 12 and/or monitor the natural electrical properties of the reservoir as a function of time and production rate.

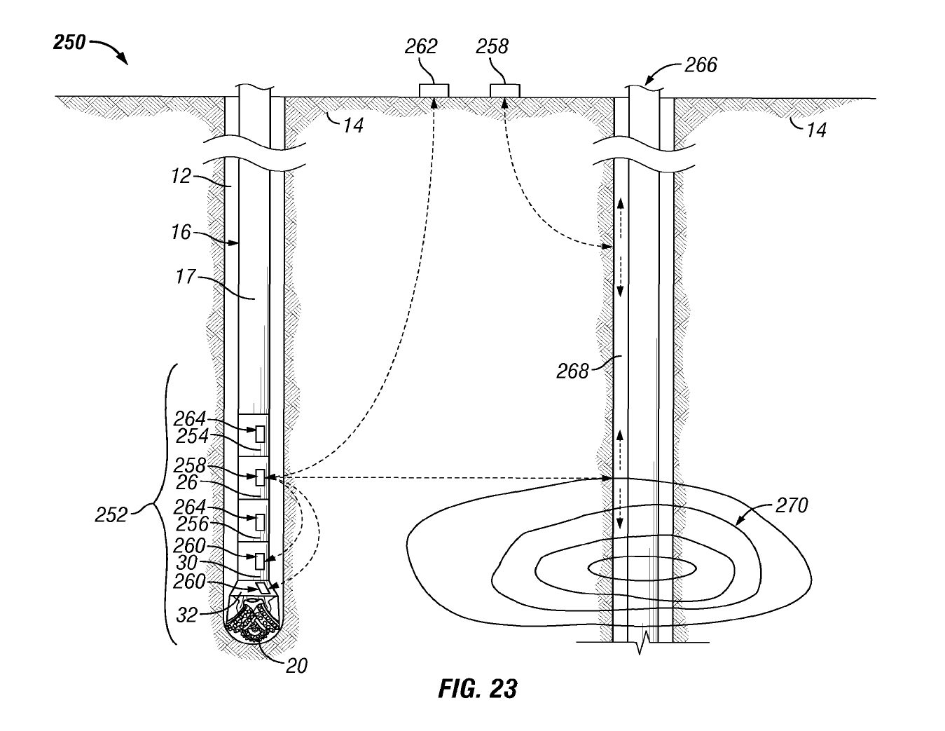

FIG. 23 shows wellsite system 250 which may have the drill string 16 and a bottom hole assembly 252 (hereinafter “BHA 252”) which may be connected to the drill string 16. The drill string 16 and/or the BHA 252 may be positioned inside the borehole 12 in the formation 14. The BHA 252 may include downhole components 26, 30, 32, the drill bit 20 and other downhole components, such as, for example, composite drill collars 254, 256. The composite drill collars 254, 256 may be made of the non-conductive or substantially non-conductive composite material. For example, the composite drill collar 254 may be located and/or positioned between the one or more drill pipes 17 and downhole component 26, and composite drill collar 256 may be located and/or positioned between downhole component 26 and downhole components 30, 32.

In embodiments, at least one of the downhole components 26, 30, 32 may be a formation evaluation tool which may perform and/or collect rock formation conductivity measurements by supplying a current between a pair of electrodes and measuring the voltage between the pair of electrodes in contact with the formation 14. In embodiments, the downhole components 26, 30, 32 may have one or more transmitters, receiver and/or detectors. For example, the downhole component 26 may have a first electrode 258, and at least one of the downhole components 30, 32 may have a second electrode 260. Alternatively, the first electrode 258 may be located at the surface 11. At least one of the first and second composite drill collars 254, 256 may be located and/or positioned between the first electrode 258 and the second electrode 260. The first electrode 258 may be configured and/or adapted to transmit current into the borehole 12 and/or the formation 14, the current may transverse the borehole 12 and/or the formation 14, and the second electrode 260 may be configured and/or adapted to detect and/or receive the current from the borehole 12 and/or the formation 14. As a result, the second electrode 260 may detect and/or receive current from the borehole 12 and/or the formation 14 which may have been transmitted from the first electrode 258. At least one of the downhole components 30, 32 may collect measurements related to characteristics and/or properties of the borehole 12 and/or formation 14 based on the current detected and/or received from the borehole 12 and/or the formation 14. The first and second composite drill collars 254, 256 may have at least one receiver 264 which may be configured and/or adapted to collect one or more measurements related to one or more characteristics and/or properties associated with the borehole 12 and/or the formation 14.

For example, the first electrode 258 may transmit and/or emit an electrical current which may be prevented and/or blocked from entering the drill pipes 17 via the first composite drill collar 254 which may have insulating properties and/or the downhole components 30, 32 via the second composite drill collar 256 which may have insulating properties. As a result, the electrical current may be radiated into the borehole 12 and/or the formation 14 via the first and/or second composite drill collars 254, 256, and the second electrode 260 of at least one of the downhole component 30, 32 may detect and/or receive the radiated electrical current from the borehole 12 and/or the formation 14. Alternatively, the first electrode 258 at the surface 11 may transmit and/or radiate an electrical current into the borehole 12 and/or the formation 14, and the second electrode 260 of at least one of the downhole component 30, 32 may detect and/or receive the electrical current from the borehole 12 and/or the formation 14. At least one of the downhole components 30, 32 may collect one or more measurements relating to one or more characteristics and/or properties of the borehole 12 and/or the formation 14 based on the current received by the second electrode 260.

Presence of a metallic component, such as, for example, a metallic drill collar near and/or adjacent to the first and second electrodes 258, 260 may cause unwanted current flows into the metallic component. As a result of the unwanted current flows, the sensitivity to the formation resistivity may be substantially reduced, this may require one or more compensation methods to be utilized to minimize the effects of the unwanted current flows. Additionally, the unwanted current flows may cause a voltage drop across the first and second electrodes 258, 260. By providing at least one of the first and second composite drill collars 254, 256 between the first and second electrodes 258, 260, the unwanted current flows through the first and/or second composite drill collar 254, 256 may be minimized or eliminated. As a result, the formation resistivity may be increased which may eliminate the need for using the one or more compensation methods for the unwanted currents flows. Use of first and/or second composite drill collars 254, 256 to minimize and/or eliminate unwanted current flows may also improve other downhole measurements, similar to a laterolog, such as, for example, surface to borehole LWD measurements in which a pair of current generating electrodes may be on the surface 11 and a pair of voltage measuring electrodes may be mounted downhole on at least one of the first and second composite drill collars 254, 256.

In embodiments, some logging applications may require an electrical gap between two conductors, such as, for example, downhole components 26 and 30 which may be created by the second composite drill collar 256. A first electrical current source may be provided above the second composite drill collar 256 by downhole component 26, the first electrode 258 of the downhole component 26 or the first electrode 258 at the surface 11. A second electrical current source may be provided below the second composite drill pipe 256 by the at least one of the downhole components 30, 32 or by the second electrode 260 of at least one of the downhole components 30, 32.

By providing an electrical gap between the first and second electric sources via the second composite drill collar 256, current may be transmitted and/or radiated into the borehole 12 and/or the surrounding formation 14 and may provide an electric dipole radiation pattern within the borehole 12 and/or the formation 14. Alternatively, the electrical gap created by the second composite drill collar 256 may be used to electrically isolate the downhole component 26 from the downhole components 30, 32 in which case the electrical gap may not be acting as a source. Instead, the electrical gap created by the second composite drill collar 256 may be a receiver, and presence of the electrical gap created by the second composite drill collar 256 may prevent shorting an electrical potential which may develop on metallic components that may be present above (i.e., the downhole component 26) and below (i.e., the downhole components 30, 32) the electrical gap created by the second composite drill collar 256.

An electrical gap may be created by the first composite drill collar 254 and may be used for wireless telemetry wherein an excitation current may be modulated at a telemetry source, such as, for example, the downhole component 26. The modulated current transmitted and/or emitted from the downhole component 26 may be radiated into the borehole 12 and/or formation 14 by the electrical gap created by the first composite drill collar 254. As a result, the modulated current may propagate in the borehole 12 and/or the formation 14 which may be detected at some distance away, such as, for example, by a detector 262 at the surface 11 as shown in FIG. 23. The detector 262 may interpret the received modulated current as telemetry data from the telemetry source.

The electrical gaps created by first and/or second composite drill collars 254, 256 may create and/or lead to the electric dipole radiation pattern, and the strength of the electric dipole radiation pattern may be proportional to a length of the electrical gap. The length of the electrical gaps may be determined by the lengths of the first and second composite drill collars 254, 256 which may be, for example, a few centimeters to several meters. Additionally, a depth of penetration for the current radiated from the electrical gap may be proportional to the length of the electrical gap. As a result, the electrical gaps created by the composite drill collars 254, 256 may be capable of generating improved and/or enhanced electric dipole radiation patterns with substantially large depths of penetration. Moreover, use of the first and/or second composite drill collars 254, 256 to create electrical gaps may allow downhole components to collect enhanced measurements relating to characteristic and/or properties of the borehole 12 and/or the formation 14, such as, for example, resistivity of the formation 14.

The electrical gaps created by first and/or second composite drill collars 254, 256 have at least one receiver 264 and lengths of the electrical gaps may be proportional to a resolution of measurements which may be collected by the receiver 264. The length of the electrical gaps and the composite drill collars 254, 256 may be designed based on the desired resolution of measurements collected by the receiver 264 and may be incorporated into the BHA 252.

The electrical gap may be created by at least one of the first and second composite drill collars 254, 256 which may have the receiver 264 for measuring electrical potentials developed in an environment of the borehole 12. The one or more receivers 264 may be configured and/or adapted to receive one or more electrical potentials, such as, for example, electrokinetic potentials, induced potentials and/or the like. In embodiments, electrokinetic potentials may be used for collecting well logging measurements, such as, for example, spontaneous potential measurements which may be caused by a salinity difference between an invading fluid and a virgin fluid coupled with a membrane potential of shale layers. Other electrokinetic potentials that may be measured may include streaming potentials, electro-acoustic potentials, electro-osmosis and/or the like. The electrical potentials that may be received by the at least one receiver 264 may be any electrical potential as known to one of ordinary skill in the art.

With induced potentials, the electrical gap created by the first composite drill collar 254 may be a current source with respect to the electrical gap created by the second composite drill collar 256 and/or the receiver 264 of the second composite drill collar 256. Alternatively, the current source may be any source of current that may use the electric current to induce a potential difference at the receiver 264 of the second composite drill collar 256. The downhole components 26, 30 on the both sides of the electrical gaps created by the second composite drill collar 256 may have metallic material incorporated therein and may act as equipotential surfaces, but the respective potentials of the downhole components 26, 30 may not be the same. Thus, the metallic material of the downhole components 26, 30 may be used as electrodes to measure the potentials. Alternatively, the first and second electrodes 258, 260 may be provided and/or utilized to measure the potentials.

In embodiments, the electrical gap that may be created by at least one of the first and second composite drill collars 254, 256 may have a length that is large or substantially large, such as, for example, several meters. As a result, electrical current that may radiate from the electrical gap may have increased intensity and/or proportionally deeper depth of penetration into the formation 14. The increased intensity and deeper depth of penetration into the formation 14 may allow the wellsite system 250 to perform cross-well type measurements, such as, for example, resistivity, with an adjacently located target well 266 (hereinafter “target well 266”). Moreover, the increased intensity deeper depth of penetration into the formation 14 may allow the wellsite system 250 to perform other large scale measurements, such as, for example, borehole to surface measurements, surface to borehole measurements and/or the like

For example, the first electrode 258 of the downhole component 26 may emit an electrical current which may be radiated into the formation 14 by the first and second composite drill collars 254, 256. Alternatively, the first electrode 258 at the surface 11 may emit an electrical current which may radiate into the formation 14. The electrical current from the first electrode 258, either of the downhole component 26 or at the surface 11, may propagate through the formation 14 and/or may reach a metal casing or component 268 (hereinafter “metal casing 268”) of the target well 266 as shown in FIG. 23. The electrical current that reached the metal casing 268 may propagate through the metal casing 268 and create at least one electromagnetic field 270 which may extend and/or propagate into the formation 14. The second electrode 60 of at least one of the downhole components 30, 32 detect the at least one electromagnetic field 270 created by the metal casing 268 of the target well 266. As a result, at least one of the downhole components 30, 32 may collect one or more measurements relating to one or more characteristics and/or properties associated with the metal casing 268 and/or the target well 266. In embodiments, the receive 264 of at least one of the first and second composite drill collars 254, 256 may detect the at least one electromagnetic field 270 created by the metal casing 268 of the target well 266. As a result, at least one of the first and second composite drill collars 254, 256 may collect one or more measurements relating to one or more characteristics and/or properties associated with the metal casing 268 and/or the target well 266.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A system for collecting at least one measurement within a borehole formed in a formation, the system comprising:
a drill collar made of a non-conductive or substantially non-conductive composite material positioned within the borehole;
a downhole component capable of collecting a measurement and embedded within the composite material of the drill collar, wherein the measurement collectable by the downhole component relates to the borehole or the formation about the borehole.

2. The system according to claim 1, wherein the composite material is fiber reinforced polymer composite material.

3. The system according to claim 1, wherein the downhole component is embedded within a wall of the drill collar and is configured to collect the measurement through the wall of the drill collar.

4. The system according to claim 1, wherein the downhole component comprises at least one first coil, an antenna, a sensor or an electrically isolated electrode.

5. The system according to claim 4 further comprising:
a retrievable mandrel having a second coil positioned within an interior of the drill collar, wherein the retrievable mandrel and the downhole component embedded within the drill collar are adapted to transmit or receive a wireless communication via the at least one first coil of the downhole component and the second coil of the retrievable mandrel.

6. The system according to claim 5, wherein the wireless communication comprises wireless telemetry data, wireless electronic instructions or wireless electrical power.

7. The system according to claim 5, wherein the wireless communication between the retrievable mandrel and downhole component embedded within the drill collar comprises radio frequency signals.

8. The system according to claim 1, wherein the measurement collectable by the downhole component is an electrical potential measurement, an electromagnetic wave measurement, a gamma radiation measurement, an acoustic measurement, a nuclear measurement, a resistivity measurement or a conductivity measurement.

9. A method for collecting at least one measurement within a borehole formed in a formation, the method comprising:
deploying a downhole component within the borehole, wherein the downhole component is capable of collecting a measurement relating to the borehole or the formation about the borehole;
protecting the downhole component with a shielding element made of non-conductive or substantially non-conductive fiber reinforced polymer composite material.

10. The method according to claim 9, wherein the downhole component is a logging-while-drilling tool, measuring-while-drilling tools, near-bit tool, or a wireline configurable tools.

11. The method according to claim 9, wherein the downhole component is embedded within the composite material of the shielding element.

12. The method according to claim 9, further comprising:
collecting the measurement through the shielding element with the downhole component.

13. The method according to claim 9, wherein the shielding element is formed as a drill collar, a sleeve or a pair of interlocking half shells.

14. The method according to claim 9, further comprising:
embedding metallic materials within the composite material of the shielding element, wherein the metallic materials are metallic strips or tilted coils.

15. A method for collecting at least one measurement within a borehole formed in a formation, the method comprising:
positioning a drill string having a bottom hole assembly within the borehole; and
electrically insulating a first position on bottom hole assembly from a second position on the bottom hole assembly with a drill collar made of non-conductive or substantially non-conductive composite material.

16. The method according to claim 15, wherein the composite material is fiber reinforced polymer composite material.

17. The method according to claim 15 further comprising:
embedding at least one acoustic attenuator, flow line for hydraulic fluids, or energy harvesting device within the composite material of the drill collar.

18. The method according to claim 15 further comprising:
embedding a coil, an antenna, a sensor, a hollow metallic cube, an acoustic impedance ring, an energy harvesting piezoelectric strip, or an energy harvesting electromagnetic device within the composite material of the drill collar.

19. The method according to claim 15, further composing:
positioning a transmitter at the first point on the bottom hole assembly; and
positioning a receiver at the second point on the bottom hole assembly.

20. The method according to claim 15, further comprising:
radiating a signal or current into the formation from the first position of the bottom hole assembly; and
detecting the signal or current in the formation at the second position of the bottom hole assembly or with a detector at a surface of the formation.
